(19) United States
(12) Patent Application Publication
(10) Pub. No.: US 2023/0289644 A1
(43) Pub. Date: Sep. 14, 2023

(54) Strong spin-microwave coupling for quantum technologies

(71) Applicant: The Board of Trustees of the Leland Stanford Junior University, Stanford, CA (US)

(72) Inventors: Eric I. Rosenthal, San Mateo, CA (US); Christopher P. Anderson, Menlo Park, CA (US); Jelena Vuckovic, Palo Alto, CA (US)

(21) Appl. No.: 18/121,412

(22) Filed: Mar. 14, 2023

Related U.S. Application Data
(60) Provisional application No. 63/319,503, filed on Mar. 14, 2022.

(51) Int. Cl. G06N 10/40

(52) U.S. Cl. CPC G06N 10/40

(57) ABSTRACT

Improved spin-microwave coupling is provided using a microwave cavity having a galvanic element connecting two points on its walls. This configuration can provide an unusual cavity mode having a highly concentrated magnetic field (to provide good coupling to a spin system) and a spread-out electric field (to reduce loss, since the electric field is almost entirely in vacuum). The galvanic element preferably includes a nano-scale current concentration feature (i.e., sub 100 nm lateral dimensions) to concentrate the magnetic field. The spin system of interest is preferably disposed in proximity to this current concentration feature. Applications include coherent quantum optical-microwave transduction and quantum memories.

### CROSS REFERENCE TO RELATED APPLICATIONS

This application claims priority from U.S. Provisional Patent Application 63/319,503 filed Mar. 14, 2022, which is incorporated herein by reference.

### GOVERNMENT SPONSORSHIP

This invention was made with Government support under contract DE-AC0276515 awarded by the Department of Energy, and under contract DE-SC0020115 awarded by the Department of Energy. The Government has certain rights in the invention.

### FIELD OF THE INVENTION

This invention relates to coupled microwave-spin systems.

### BACKGROUND

Quantum solid-state spin centers are created when atoms in a semiconductor crystal lattice are replaced by something else; different atoms and/or vacant sites. This can lead to an unpaired electron in the lattice, localized at the defect, whose spin degree of freedom (“up” or “down”) may be used as a qubit. These solid-state spins can have minutes-long coherence times, scalable on-chip integration, and long-distance networking via an optical interface.

To utilize solid-state spins in quantum technologies, many groups have worked on coupling them to superconducting microwave cavities. Such experiments to-date have used ensembles of spins, which enhance coupling as \sqrt{N}, with N being the number of spins in the ensemble. However, an ensemble of spins is conceptually similar to a harmonic oscillator, not a two-level system, limiting its use in many quantum applications. Weak coupling to the electromagnetic field compared to system losses has thus-far prevented coherent interaction between individual solid-state spins and microwave photons.

Accordingly, it would be an advance in the art to provide improved coupling of spin systems to microwave cavities, especially for single-spin systems.

### SUMMARY

This work provides coupling/interaction between microwave photons and solid-state quantum spins in a way which is strong compared to loss. This will enable individual spins, or ensembles of spins, to be used in applications such as high fidelity quantum transduction and quantum information processing. Solid-state spins can have excellent properties but are generally limited by their weak coupling/interaction with the electromagnetic field.

We design and simulate a microwave cavity with a particular geometry chosen to have a small magnetic mode volume localized at a solid-state spin, for strong coupling. Spins are magnetic dipoles, and couple to the magnetic field. But also, the relevant cavity mode has a large electric mode volume where most of the electric field is stored in the vacuum of a 3-dimensional cavity, thus leading to low loss. This design is predicted to have considerably lower loss than previous designs while also having strong coupling.

In particular, this cavity design features an electromagnetic cavity with two walls of the cavity connected to each other by a specialized shorting element. This shorting element is an unusual feature of an electromagnetic cavity because it galvanically contacts the two walls (i.e., there is a continuous electrically conductive path between the walls provided by the shorting element). The impedance of this shorting element is low enough such that a non-trivial fraction of the total current in the cavity mode flows through the shorting element (for example, this fraction can be 1% or more and is more preferably 5% or more, and still more preferably is as high as possible). Note that it is difficult for this fraction to approach unity because of the already low impedance of the exterior cavity walls. In design examples considered so far, this fraction tends to be roughly 15%.

Furthermore, the cross section area of this short can be constricted, enhancing the current density at the constriction. This leads to a strong and localized (i.e. concentrated to a region much smaller than the cavity volume) magnetic field that is suitable for interacting with solid state spins. In contrast, a conventional cavity would not have a localized magnetic field (as defined above) at all.

An exemplary embodiment of the invention is apparatus for spin-microwave coupling, including: a microwave cavity resonator having one or more electrically conductive walls that enclose and define a cavity; a galvanic element connecting a first location on the one or more electrically conductive walls to a second location on the one or more electrically conductive walls; and a spin element disposed in proximity to the galvanic element.

Here a “microwave cavity resonator” is an electromagnetic resonator having one or more electrically conductive walls that enclose and define a cavity. The cavity can contain gas, but is often operated at cryogenic temperatures such that the cavity is kept under vacuum by cryogenic pumping. We define microwave radiation as electromagnetic radiation in a frequency range from 300 MHz to 300 GHz. A galvanic element is an electrically conductive element that is conductive for DC currents (i.e., its impedance is resistive and/or inductive). Thus, a capacitor is not a galvanic element. A spin element is any physical system having one or more spin degrees of freedom that can couple to a local magnetic field.

Preferably the one or more electrically conductive walls include parallel first and second plates having a spacing less than 0.1× their lateral dimensions, where the first location is on the first plate, and where the second location is on the second plate and opposite the first location.

The galvanic element preferably includes a geometrical current concentration feature, and the spin element is preferably disposed in proximity to the geometrical current concentration feature.

The one or more electrically conductive walls and/or the galvanic element can include at least one superconductor material.

The spin element can be a single spin system or it can be an ensemble of two or more spin systems.

The galvanic element is preferably disposed at an electric field node of the apparatus.

The galvanic element can be an integral part of the microwave cavity resonator. Alternatively, the galvanic element and the spin element can be integrated on a common substrate. The common substrate is then bonded to and electrically connected to the microwave cavity resonator.

In cases where a common substrate is used for the galvanic element and spin element, it is preferred that electrical connections between the galvanic element and the microwave cavity resonator include indium bump-bonds between the common substrate and the microwave cavity resonator.

An optical resonator can be disposed on the common substrate and coupled to the spin element, to provide quantum microwave-optical transduction. Another application of this technology is quantum memory.

### BRIEF DESCRIPTION OF THE DRAWINGS

FIGS. 1A-B show an exemplary embodiment of the invention.

FIGS. 1C-D are field simulations showing a cavity mode with concentrated magnetic field and spread-out electric field.

FIG. 1E shows an alternate configuration of the galvanic element, in which the cavity wall(s) and galvanic element are machined from the same block of metal.

FIGS. 2A-B are simulation results showing that a significant fraction of total current passes through the galvanic element.

FIG. 3A shows inclusion of the spin system that is coupled to the microwave cavity in a photonic resonator.

FIG. 3B is a more detailed view of the example of FIG. 3A.

### DETAILED DESCRIPTION

### I) Introduction

Quantum solid-state spin centers are created when atoms in a semiconductor crystal lattice are replaced by something else; different atoms and/or vacant sites. This can lead to an unpaired electron in the lattice, localized at the defect, whose spin degree of freedom (“up” or “down”) may be used as a qubit. These solid-state spins can have minutes-long coherence times, scalable on-chip integration, and long-distance networking via an optical interface.

To utilize solid-state spins in quantum technologies, many groups have worked on coupling them to superconducting microwave cavities. Such experiments to-date have used ensembles of spins, which enhance coupling as \sqrt{N}, with N being the number of spins in the ensemble. However, an ensemble of spins is conceptually similar to a harmonic oscillator not a two-level system, limiting its use in many quantum applications. Weak coupling to the electromagnetic field compared to system losses has thus-far prevented coherent interaction between individual solid-state spins and microwave photons.

### II) Methods

### II-A) Example Design

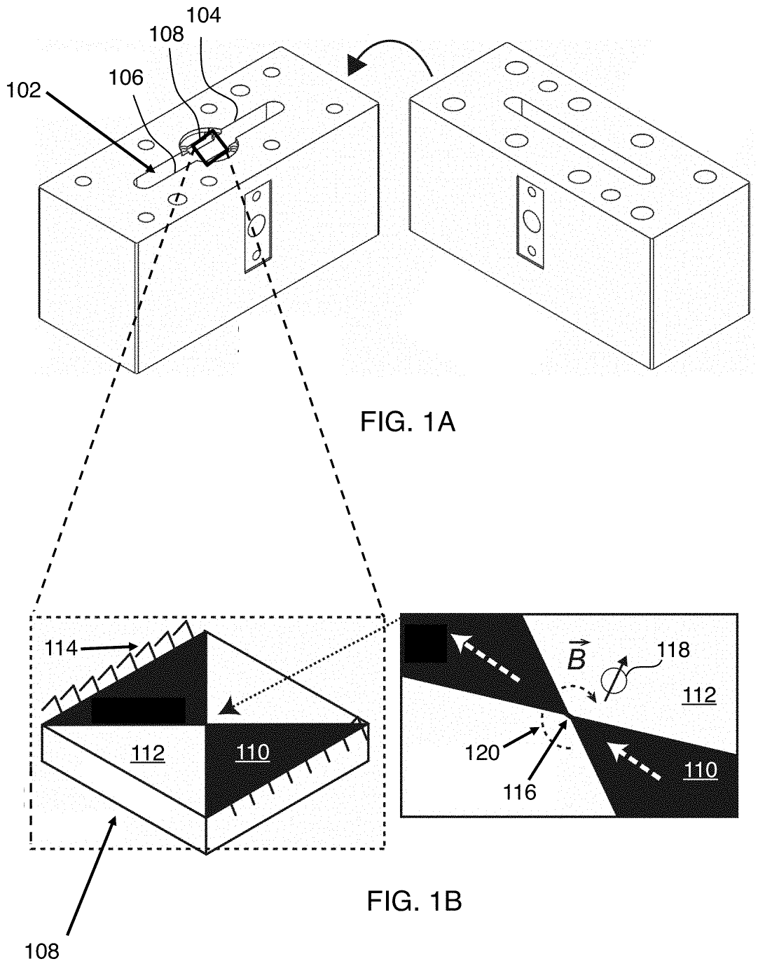

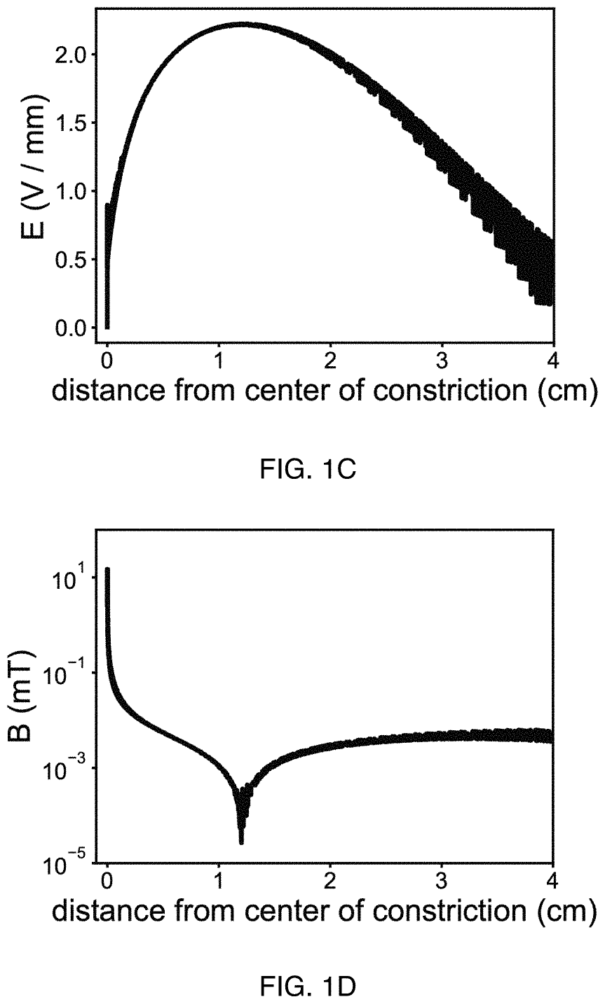

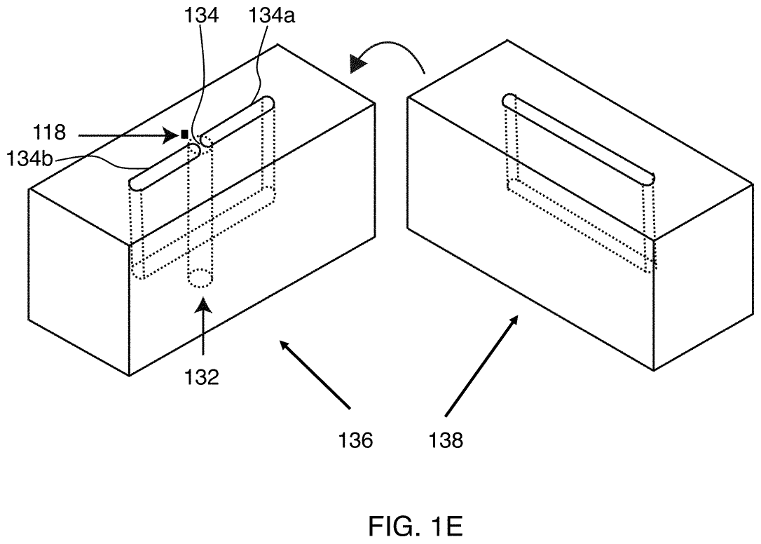

FIG. 1A shows a “2.5-dimensional” microwave cavity, constructed from a standard 3-dimensional cavity 102 by adding a galvanic element 108 connecting its two opposite sides 104 and 106. This galvanic element can include metal 110 patterned onto a semiconductor chip 112, then bonded to the cavity walls (e.g., via bonds 114). FIG. 1B is an enlarged view of the center of this galvanic element. For a galvanic element that is constricted at its center, e.g. the “bowtie” geometry shown having a constriction 116, the current density of the fundamental cavity eigenmode is large at the constriction, leading to a strong, localized magnetic field 120. This allows the cavity to couple strongly to a magnetic dipole placed in the region of high magnetic field, e.g. a spin or ensemble of spins (i.e., spin system 118). FIGS. 1C-D are simulations showing the electric and magnetic fields, respectively, of the cavity fundamental mode, plotted as a function of radial distance from the center of the constriction. The large electric mode volume allows for low loss, but the small magnetic mode volume allows for strong coupling. These simulations are for a cavity whose fundamental eigenmode frequency is at 3.01 GHz, but the general 2.5-dimensional concept and design is valid for a wide variety of cavities, including a wide range of mode frequencies, and including both the fundamental and higher-order modes.

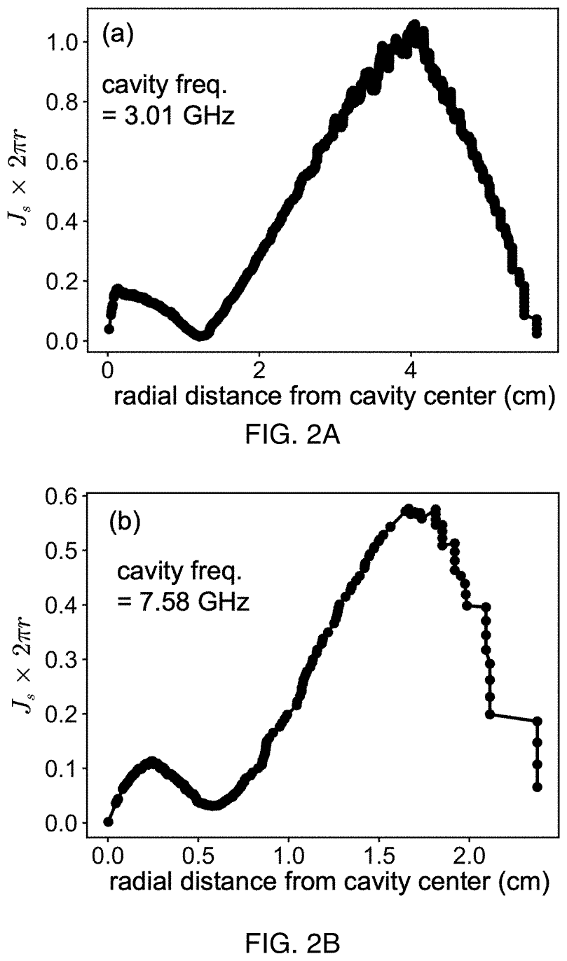

In the example of FIGS. 1A-B, the two large faces (104 and 106) of the rectangular cavity function as two sides of a parallel plate capacitor. Current flows back-and-forth between them along both the cavity walls and the metal 110 on chip 112, which can be patterned into a “bowtie” geometry constricted at the center. Because a similar amount of current flows across the centimeter-scale cavity walls as does across the nanoscale constriction of the bowtie, the current density is commensurately higher at the constriction, comprising a relatively large fraction of current in the cavity mode. Further details on the fraction of current flowing through the constriction are provided below in the description of FIGS. 2A-B.

Due to this high current density at the constriction, the magnetic field of this mode is localized around the chip/constriction. The electric field, however, lives almost entirely in the 3-dimensional vacuum of the cavity, mitigating loss associated with surface effects or the dielectric loss of the semiconductor chip. To visualize this, the electric and magnetic fields of the fundamental mode of this example are plotted in FIGS. 1C-D. The electric field forms a spread-out doughnut-shape around the chip, with a node at its center. The magnetic field is sharply maximized near the chip/constriction. Note the linear scale for the electric field and the log scale for the magnetic field. A cavity mode like this, having a concentrated magnetic field and a spread-out electric field, is not typical in the field of superconducting electronics. Often, cavity modes have comparable spatial scales for their electric and magnetic fields. For example, 3-dimensional cavities (e.g. our design without the galvanic short) have similarly large electric and magnetic mode volumes both spread out in vacuum, or, planar lumped element resonators have similarly small electric and magnetic mode volumes, both relatively confined within a chip.

In order to further reduce loss, the chip 112 can be patterned with superconducting metal 110 and the entire system can be cooled to cryogenic temperatures. For lowest loss, the cavity walls can also be machined from superconducting metal, chemically treated, and connected to the patterned chip via indium bump bonding.

The constriction could alternatively be machined from the same block of metal as the cavity wall(s) (FIG. 1E). Such a constriction removes the seam loss associated with connecting a 2-dimensional chip to the 3-dimensional cavity, but makes it more challenging to place a single spin or small ensemble extremely close to a nanoscale-sized constriction. In the example of FIG. 1E, a first part 136 part is machined to have two closely-spaced cavities 134a and 134b. A hole 132 is drilled almost but not quite all the way through part 136, resulting in formation of a constriction 134, and combination of cavities 134a and 134b to form a single cavity. To avoid radiative loss, hole 132 is preferably sized to be small enough so that the fundamental mode of the assembled cavity is below the cutoff frequency of the waveguide formed by the drill hole. After this machining, chemical etching can be performed to further reduce the width of the constriction. Spin system 118 is placed in proximity to constriction 134. The microwave cavity resonator is then formed by affixing parts 136 and 138 to each other to enclose the cavity.

Alternatively, the “flute method” of drilling holes at alternating angles can be used to machine the constriction from the same block of metal as the cavity wall(s).

FIGS. 2A-B show simulation results of current flow through the constriction and the cavity walls. These simulations are for a cavity with a fundamental mode at 3.01 GHz (FIG. 2A) and a fundamental mode at 7.58 GHz (FIG. 2B). The plots show the total current flowing across the surface of the inner walls (104 and 106 in FIG. 1A) of the cavity as a function of radial distance r from the center of the constriction, which is equal to the current density Jₛ multiplied by 2πr. The smaller peak near r=0 quantifies I_{const}: current in the fundamental mode flowing through the constriction, and the larger peak at higher r quantifies I_{walls}: the current in the fundamental mode flowing across the walls. These simulations show that 12.3% and 14.1% of current in the fundamental mode flows through the constriction in FIG. 2A and FIG. 2B, respectively.

### II-B) Estimating Single Spin Coupling

To quantitatively analyze this design, we first review how the geometry of a microwave cavity affects its coupling to a quantum spin center.

The spin is described by two energy levels |0 [symbol] and |1 [symbol] whose separation is generally dependent on the magnetic field at the spin location. The interaction Hamiltonian between a single spin and a cavity at the same frequency is Hᵢₙₜ/ℏ=g₀(σ₊a+σ_a^{†}), where σ₊=|1 [symbol] [symbol] 0| and σ_=|0 [symbol] [symbol] 1| are the spin's Pauli raising and lowering operators, respectively, and a^{†} and a are the cavity field's creation and annihilation operators. Energy is exchanged between the spin and cavity at the rate

g₀=−γₑB· [symbol] 0|S11 [symbol] . (1)

Here, γₑ=28 GHz/T is the electron gyromagnetic ratio, S is the spin operator of the spin center, and B=B₀(a+a^{†}) is the magnetic field operator.

The magnitude of the field operator is set by B₀, the zero-point fluctuations of the magnetic field at the spin's location:

$${B}_{0} = \sqrt{\frac{ℏω}{2 {V}_{B} / {μ}_{0}}} . \qquad ( 2 )$$

Here, ω/2π is both the cavity resonant frequency and the spin frequency, and V_{B} is the effective magnetic mode volume of the cavity at the spin's location \vec{r}ₛ,

$${V}_{B} = \frac{\int dV {\vert \vec{B} ( \vec{r} ) \vert}^{2}}{{\vert \vec{B} ( {\vec{r}}_{s} ) \vert}^{2}} \qquad ( 3 )$$

The numerator of Eq. 3 is a volume integral of the magnetic field squared over the entire cavity, and the denominator is the magnetic field squared at the spin location only. Note that here, it is assumed the cavity has the vacuum permeability of free space, μ₀, over its entire extent. Eq. 2 and Eq. 3 may be modified for general p.

The coupling rate g₀/2π between the cavity and spin center's spin is therefore determined by a cavity's effective magnetic mode volume V_{B}. Decreasing V_{B} increases the magnetic field at the spins's location, increasing coupling.

### III) Results

Guided by this understanding, we use numerical finite-element modelling (COMSOL) to simulate the coupling rate between a single spin and a 2.5-dimensional microwave cavity.

Here, we present two simulated versions of the 2.5-dimensional cavity design. One design has a fundamental mode at 3.01 GHz, designed to couple to the NV− center in diamond (S=1) which has a spin transition of 2.87 GHz at zero magnetic field. The other design has a fundamental mode at 7.57 GHz, designed to couple to a bismuth center in silicon (S=½) which has a spin transition of 7.38 GHz at zero magnetic field. These designs are simulated to have coupling rates of g₀/2π=3.958 kHz and g₀/2π=3.016 kHz, respectively, for a spin placed 20 nm away from the edge of a 20 nm wide constriction. Coupling falls off inversely with distance from the constriction.

For a preliminary experimental demonstration, we estimate a cavity internal loss rate of κᵢₙₜ/2π≈1 MHz using cavity walls made of copper (non-superconducting), and using wire bonds to connect a 2-dimensional chip to these walls. Loss is expected to be dominated by the packaging loss associated with the wire bonds, assuming order 10 wire bonds on each side of the chip. The second dominant contribution to loss is expected to be the skin effect of the normal metal copper walls.

In a more sophisticated demonstration, indium bump bonding can be used to mitigate packaging loss, and the cavity walls can be machined from superconducting metal including aluminum, niobium or tantalum. Finally, the cavity surface can be chemically treated after machining. These improvements should result in an internal loss rate similar to previously demonstrated 3-dimensional superconducting microwave cavities, which can have κᵢₙₜ/2π≤1 kHz. COMSOL simulations show that dielectric loss of the semiconductor chip is expected to be negligible (less than 1 kHz, using a loss tangent of tan δ=10⁻⁵), because the chip lies at an electric field node and is spatially small compared to the volume of the cavity.

In summary, we expect the 2.5-dimensional design to compare favorably to previous work, yielding both high single-spin coupling rates and far lower loss when engineered using indium bump bonding and superconducting metal. Our design approaches the strong-coupling limit for a single spin placed 20 nm from the constriction. Even for spins further away, coupling to a small ensemble of N spins will greatly exceed loss as the ensemble coupling rate is enhanced by \sqrt{N}.

### IV) Applications

### IV-A) Transduction for Quantum Networks

One important application of the 2.5-dimensional cavity design is quantum transduction between microwave and optical photons.

Creating entangled quantum states over long distances is necessary for quantum sensing, communication and information protocols. This must generally be done using optical photons, which may be transmitted over long distances with negligible loss or decoherence.

Superconducting qubits are one of the leading architectures for quantum computing, but use microwave photons which cannot be transmitted over long distances due to cable loss and the requirement that they remain in a cryogenic environment. Optical photons can be transmitted with high fidelity over km-scale distances at room temperature, and therefore coherent transduction between microwave and optical photons will allow the long-distance networking of superconducting quantum processors. Transduction at low enough loss rates to be useful is difficult to engineer, however, because of the vast energy difference between microwave and optical photons.

Quantum spin centers in semiconductors are useful for transduction because they have both optical transitions and microwave frequency spin transitions, which may both be coherently manipulated. Optical quantum networks between multiple quantum spin centers (“quantum emitters”) have already been demonstrated, but not in a system which also has strong coupling to microwave photons.

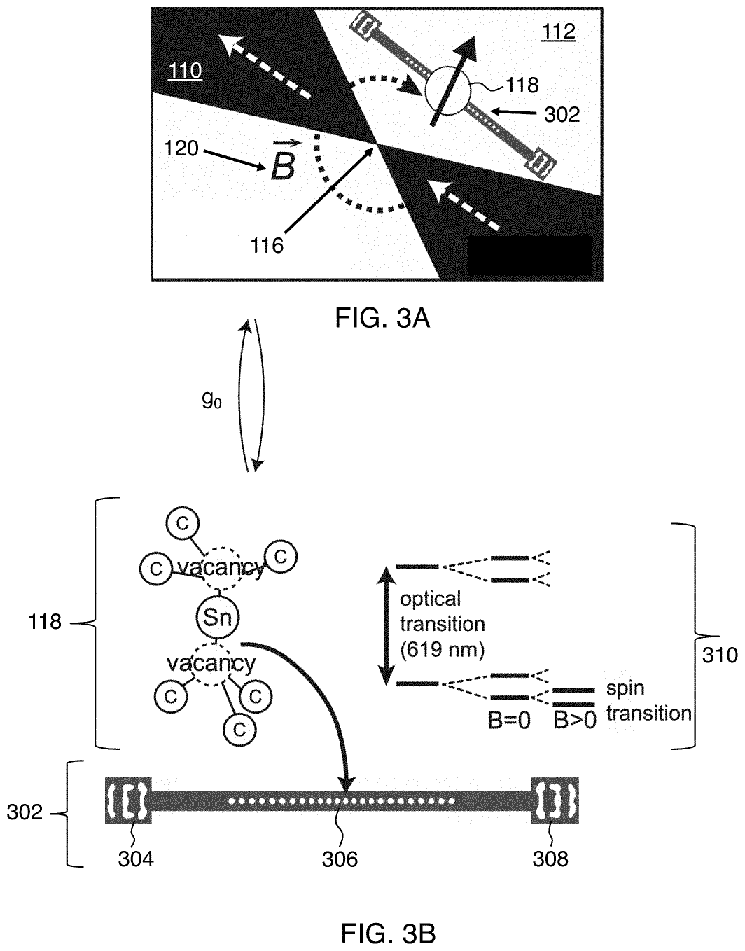

A promising architecture for transduction is a 2.5-dimensional cavity that is strongly coupled to a single spin center, for a center that is integrated into a nanophotonic structure with optical readout, as in the example of FIGS. 3A-B.

FIGS. 3A-B show transduction between microwave and optical photons using a 2.5-dimensional cavity. FIG. 3A shows a photonic resonator 302 in proximity to the constriction 116 and including the spin system 118. As seen on FIG. 3B, the quantum spin system 118 is embedded in a photonic nanostructure used to couple to its optical degree of freedom. For example, a single tin-vacancy (SnV−) center in a diamond can be embedded into a photonic cavity 306 combined with inverse-design waveguide couplers 304 and 308, allowing for high collection efficiency of optical photons emitted by the spin center. Pertinent energy levels for this example are shown in inset 310. Many other types of emitters may be used, in addition to or instead of the (SnV−) center. For example emitters may be used which have spin transitions split to microwave frequencies at zero-field (e.g. the NV− center in diamond), or, those which do not, e.g. group IV centers in diamond (including silicon, germanium and tin centers in diamond), which are a promising platform for building quantum networks. For large enough coupling g₀ compared to loss, optical photons can be coherently entangled with microwave photons in the 2.5-dimensional microwave cavity.

In such a system, coherent cavity quantum electrodynamics may be implemented in both the microwave and optical domain. With low loss and high coupling, this will allow a microwave photon in the 2.5-dimensional cavity to coherently swap into the microwave frequency spin degree of freedom of the solid-state spin, which then can be coherently manipulated into an emitted optical photon. While such a design will still have considerable loss using current technologies, it could potentially exceed the performance of current state-of-the-art optomechanical transduction schemes.

### IV-B) Memories for Quantum Computing

Finally, quantum spin centers can have lifetimes of hundreds of milliseconds or more, far outperforming the best 2-dimensional superconducting qubits, which have coherence times of 1 ms or less. Strong coupling between spin(s) and a microwave cavity will allow the long-lived spin degree of freedom to serve as a quantum memory.

Such architectures, combined with appropriate nonlinearity likely from Josephson junctions, may furthermore be used to generate nonclassical states in spin ensemble(s) (e.g. a Schrodinger cat state). Nonclassical states in linear cavities (conceptually similar to a spin ensemble) are promising for use in quantum memories and quantum error correction.

### V) Conclusions

We consider a design for a general class of “2.5-dimensional” microwave cavities in which two sides of a 3-dimensional microwave cavity are galvanically contacted by a low-impedance path, for instance a galvanic short. Such cavities exhibit both small magnetic mode volumes for strong coupling to magnetic dipoles and large electric mode volumes for low loss. This design is useful for strongly coupling quantum spin centers to microwave photons when implemented in a superconducting architecture at cryogenic temperatures. Simulations show that this design compares favorably to previous approaches.

While here we specifically consider the case of coupling to the nitrogen-vacancy (NV⁻) center in diamond and the bismuth center in silicon, this general design may be applicable to any solid-state spin system. For example, our designs may also be used with erbium doped calcium tungstate (Er³⁺:CaWO₄), a promising platform due to its low naturally occurring density of nuclear spins and its large electronic g factor (allowing for stronger coupling). Our design may also be used with the boron vacancy center in hexagonal boron nitride which has a zero field splitting of 3.5 GHz. Or, our design may be used with a host of other different spin platforms including those which have not been characterized yet.

In conclusion, the strong interaction between quantum spin centers and microwave photons enabled by this 2.5-dimensional architecture is expected to have applications in quantum transduction, communication and information processing.

1. Apparatus for spin-microwave coupling, the apparatus comprising:
a microwave cavity resonator having one or more electrically conductive walls that enclose and define a cavity;
a galvanic element connecting a first location on the one or more electrically conductive walls to a second location on the one or more electrically conductive walls; and
a spin element disposed in proximity to the galvanic element.

2. The apparatus of claim 1, wherein the one or more electrically conductive walls include parallel first and second plates having a spacing less than 0.1× their lateral dimensions, wherein the first location is on the first plate, and wherein the second location is on the second plate and opposite the first location.

3. The apparatus of claim 1, wherein the galvanic element includes a geometrical current concentration feature, and wherein the spin element is disposed in proximity to the geometrical current concentration feature.

4. The apparatus of claim 1, wherein the one or more electrically conductive walls include at least one superconductor material.

5. The apparatus of claim 1, wherein the galvanic element includes at least one superconductor material.

6. The apparatus of claim 1, wherein the spin element is a single spin system.

7. The apparatus of claim 1, wherein the spin element is an ensemble of two or more spin systems.

8. The apparatus of claim 1, wherein the galvanic element is machined to be part of the microwave cavity resonator, from the same solid piece of metal as used to form its walls.

9. The apparatus of claim 1, wherein the galvanic element is disposed at an electric field node of the apparatus.

10. The apparatus of claim 1, wherein the galvanic element and the spin element are integrated on a common substrate.

11. The apparatus of claim 10, wherein electrical connections between the galvanic element and the microwave cavity resonator include indium bump-bonds between the common substrate and the microwave cavity resonator.

12. The apparatus of claim 10, further comprising an optical resonator disposed on the common substrate and coupled to the spin element, whereby quantum microwave-optical transduction is provided.

13. A quantum memory including the apparatus of claim 1.
